(19) United States
(12) Patent Application Publication
(10) Pub. No.: US 2025/0112010 A1
(43) Pub. Date: Apr. 3, 2025

(54) ACTUATING DEVICE

(71) Applicant: Schneider Electric Industries SAS, Rueil-Malmaison (FR)

(72) Inventors: Bhoopender Singh, Lappersdorf (DE); Deepak Verma, Regensburg (DE); Tobias Humbs, Bernhardswald (DE)

(73) Assignee: Schneider Electric Industries SAS, Rueil-Malmaison (FR)

(21) Appl. No.: 18/897,252

(22) Filed: Sep. 26, 2024

(30) Foreign Application Priority Data
Sep. 28, 2023 (DE) 102023126553.9

(51) Int. Cl. H01H 17/08; H01H 3/02; H01H 3/38

(52) U.S. Cl. CPC H01H 17/08; H01H 3/38; H01H 3/0226

(57) ABSTRACT

An actuating device for a switching apparatus of a switch panel of electrical energy technology, in particular of medium-voltage technology, comprises an operable drive unit, in particular a manually operable drive unit, a pivot unit that can be mechanically coupled to the switching apparatus, and a pulling cable via which the pivot unit is mechanically connected to the drive unit.

The invention relates to an actuating device for a switching apparatus of a switch panel of electrical energy technology, in particular of medium-voltage technology.

Switch panels of electrical energy technology usually comprise a variety of equipment whose electrical voltage is monitored for a safe operation. For this purpose, voltage transformers are used that are connected to, for example, busbars or cable outlets of a switch panel. It may be necessary in this respect to temporarily disconnect (isolate) such voltage transformers from the monitored equipment and to ground them—for example for protection against damage during a high-voltage test of the switch panel or for maintenance purposes. In this respect, the circuit concerned is usually first interrupted by means of a circuit breaker and the voltage transformer is then disconnected from the monitored equipment and grounded by actuating a switching apparatus.

Furthermore, switch panels of electrical energy technology often also comprise switching apparatus by means of which busbars of the switch panel can be grounded for maintenance purposes, for example. Here, too, the circuit concerned is usually first interrupted by means of a circuit breaker and the busbar is then grounded by actuating a switching apparatus. Once maintenance has been completed, the busbar can be disconnected from the ground potential by actuating the switching apparatus and the circuit can be closed again by means of the circuit breaker.

Such a switching apparatus is usually actuated—for example for grounding a busbar or for disconnecting and grounding a voltage transformer—by manually operating a drive unit arranged at a front side of the switch panel. In this respect, the drive unit is mechanically coupled to the switching apparatus via a linkage such that the switching apparatus is actuated by operating the drive unit.

However, actuating devices comprising such a linkage require a lot of installation space and are also complex to install (i.e. in particular to attach to a switch panel) since they only allow small tolerances for the suspension points of the linkage, for example.

It is therefore the underlying object of the invention to make possible an actuating device that is easy to install and requires little installation space.

This object is satisfied by an actuating device having the features of claim 1.

In this respect, the invention is based on the idea of coupling a drive unit to a switching apparatus via a pulling cable. For this purpose, the actuating device according to the invention has an operable drive unit, in particular a manually operable drive unit, that is mechanically coupled to a pivotable pivot unit via a pulling cable that has a pulling cable start and a pulling cable end. The pivot unit is in this respect configured such that the pivot unit is pivoted by operating the drive unit via the pulling cable. If the pivot unit is mechanically coupled to the switching apparatus, the switching apparatus can be actuated by pivoting the pivot unit. For example, the pivot unit can be rotationally fixedly connected to a shaft of the switching apparatus, wherein a switching contact of the switching apparatus can be arranged on the shaft. By pivoting the pivot unit, the shaft can likewise be pivoted and the switching contact can in so doing be transposed into another switching position in which the switching contact establishes or disconnects a ground connection, for example.

The actuating device can be particularly easily installed by using the pulling cable: When installing the actuating device at a switch panel, the pivot unit is mechanically coupled to a switching apparatus of the switch panel. The drive unit can be fastened to a front side of the switch panel, for example. Since the pulling cable—unlike a linkage—can be flexibly guided (for example by means of deflection rollers), tolerances, for example of the relative position of the pivot unit and the drive unit to one another, can be easily compensated. Furthermore, the pivot unit and the drive unit can, however, also be installed in different relative positions to one another, whereby the drive unit can in particular be fastened at almost any position suitable for operation. Due to the pulling cable, not only can tolerances be easily compensated when installing the actuating device, but the actuating device can also be installed in a wide variety of suitable positions. Furthermore, the actuating device itself can also be easily installed or manufactured by using the pulling cable.

A further advantage is that the actuating device can even be installed with a small available installation space due to the mechanical coupling of the drive unit to the pivot unit via the pulling cable. On the other hand, with a linkage, minimum distances, which regularly do not allow an installation with a small available installation space, are required due to suspension points, lever deflections and/or lever displacements, for example.

Advantageous embodiments of the invention result from the dependent claims, from the description, and from the Figures.

According to an advantageous embodiment, the pivot unit can comprise a connection piece that is configured as pivotable about a pivot axis. This enables a simple mechanical coupling of the pivot unit to a switching apparatus, wherein the pivot axis of the connection piece should advantageously correspond to a pivot axis of the switching apparatus. Furthermore, the pulling cable can be connected to the connection piece with its pulling cable end spaced apart from the pivot axis. In this respect, the pulling cable does not have to be directly connected to the connection piece. Due to the connection of the pulling cable to the connection piece spaced apart from the pivot axis, a pulling movement of the pulling cable can easily generate a torque acting on the connection piece about the pivot axis, whereby the connection piece can be pivoted.

According to a further advantageous embodiment, the pivot unit can comprise a return spring that has a first return spring end and a second return spring end and that can in particular be configured as a tension spring or a torsion spring. Furthermore, the return spring can be fastened, in particular connected in an articulated manner, to the connection piece with its first return spring end spaced apart from the pivot axis. With its second return spring end, the return spring can be fastened, in particular connected in an articulated manner, to the switch panel, for example during the installation of the actuating device. If the return spring is fastened, in particular connected in an articulated manner, to the connection piece spaced apart from the pivot axis, the return spring can easily generate a torque acting on the connection piece about the pivot axis, whereby the connection piece can be pivoted. The return spring can generally have, at one or at both ends, a screw lug to which the return spring can be fastened, in particular connected in an articulated manner. The return spring can advantageously be preloaded to be able to keep the pulling cable at a defined tension at all times, whereby an operation of the actuating device without play can be achieved, for example. Using the return spring, the connection piece can be easily pivoted back again after a pivoting. For example, in the event of a pulling force which acts on the pulling cable and during which the connection piece is pivoted, the return spring can be tensioned and acted on by a spring force. If the pulling force decreases again, the connection piece can be pivoted back again by the spring force of the tensioned return spring.

According to a further advantageous embodiment, the pivot unit can comprise a first base on which components of the pivot unit can be arranged, whereby the actuating device can be easily manufactured. The pivot unit can in particular be easily fastened to a switch panel by means of the first base. The pulling cable is preferably supported at the first base. However, the pulling cable can generally also be supported in another way, for example by means of a roller fastened to a switch panel. Alternatively or additionally, the connection piece can be pivotably supported at the first base about the pivot axis. If the pivot unit is installed at a switch panel, bending moments on a shaft of a switching apparatus of the switch panel can be reduced by the pivotable support. Likewise alternatively or additionally, the return spring can be fastened, in particular connected in an articulated manner, to the first base with its second return spring end.

According to a further advantageous embodiment, the connection piece can comprise a guide pin that is spaced apart in parallel from the pivot axis. The first base can have a first guide contour in which the guide pin is guided. Advantageously, the first guide contour has the shape of a circular ring segment. The ends of the circular ring segment can each form an abutment for the guide pin, whereby the connection piece can only be pivoted within a predefined angular range. Advantageously, the angular range predefined by means of the abutments can be matched to a movement of a switching contact of a switching apparatus that is performed by the switching contact when it is transposed into another switching position. The predefined angular range is advantageously matched to a movement of the switching contact of the switching apparatus such that the guide pin abuts the respective end of the first guide contour when the switching contact is in a respective end position or switching position. Thus, end positions of the switching device can be easily defined by means of the first guide contour. The angular range can in particular be matched to the movement of the switching contact such that a force can be limited with which the switching contact is pressed against a ground contact, for example, due to the return spring—if provided. For this purpose, the first guide contour can, for example, be configured such that the guide pin abuts one end of the first guide contour in a switching position of the switching contact of the switching apparatus. In particular, a defined contact pressure can thereby be set and damage can be reduced. Furthermore, the guide pin can indicate a switching position of a switching apparatus in a visually perceivable manner.

According to a further advantageous embodiment, the pivot unit can comprise a clamping spring that has a first clamping spring end and a second clamping spring end and that can in particular be configured as a tension spring or a torsion spring. The clamping spring can be fastened, in particular connected in an articulated manner, to the connection piece with its first clamping spring end at the pulling cable end and with its second clamping spring end spaced apart from the pivot axis. The clamping spring can also have, at one of its ends or at both ends, a screw lug with which the clamping spring can be fastened, in particular connected in an articulated manner. The clamping spring is preferably preloaded to keep the pulling cable at a defined tension at all times, whereby an operation of the actuating device without play can be achieved, for example. Furthermore, a temperature-induced change in the length of the pulling cable can, for example, be compensated by means of the clamping spring and/or the return spring and an operation of the actuating device without play can thereby be enabled.

According to a further advantageous embodiment, the pulling cable can be guided in a Bowden cable sheath having a first Bowden cable sheath end and a second Bowden cable sheath end. For example, the first Bowden cable sheath end can be supported at the first base—if provided. For this purpose, the first base can comprise a cable counter-holder that receives the first Bowden cable sheath end. However, such a cable counter-holder can generally also be attached directly to the switch panel. Due to the guidance in the Bowden cable sheath, the pulling cable can be guided in a protected manner and without using deflection rollers, for example. In particular, by means of the guidance of the pulling cable in the Bowden cable sheath, the installation of the actuating device can be simplified and can even be enabled with a small available installation space.

According to a further advantageous embodiment, the drive unit can be configured to apply a pulling force to the pulling cable in order to pivot the pivot unit. For this purpose, the drive unit can, for example, comprise a pulling piece that is configured as rotatable about an axis of rotation and that can in particular have a plug-in section that is configured as connectable to a hand crank. The pulling cable can be connected to the pulling piece with its pulling cable start spaced apart from the axis of rotation. The plug-in section can be formed coaxially with the axis of rotation. The pulling cable can easily be acted on by a pulling force by driving the pulling piece by means of the hand crank. For example, the drive unit can also comprise an operable drive motor that can be configured to drive the pulling piece via a motor control to apply a pulling force to the pulling cable.

According to a further advantageous embodiment, the drive unit can comprise a releasable blocking device that can be configured to block the pulling piece and thus, via the pulling cable, the pivot unit against a pivoting. The pivot unit can thereby be easily blocked against a pivoting back in a pivoted state so that the pivot unit can only be pivoted back after a release of the blocking device. If the actuating device is installed at a switch panel, a switching contact of a switching apparatus of the switch panel can thus, for example, be transposed into a switching position or switch position and can be blocked in this switch position by means of the blocking device. In the blocked state, for example, the return spring—if provided—cannot transpose the switching contact into another switch position. However, this is possible again after releasing the blocking device. Since the drive unit comprises the releasable blocking device, the safety of a switch panel equipped with the actuating device can also be increased: Since the blocking device only blocks the drive unit directly, but blocks the pivot unit indirectly via the pulling cable, the pivot unit can be pivoted back, for example, due to the return spring—if provided—if the pulling cable breaks, for example. In this respect, a switching contact of the switching apparatus can be reliably transposed into a switch position in which the switching contact contacts a ground contact, for example. In the blocked state, the blocking device can, for example, also be secured by a padlock that must be removed again before the blocking device can be released.

According to a further advantageous embodiment, the blocking device can comprise a locking bolt having a spring-loaded locking pin. The pulling piece can have a recess that is configured as receiving the locking pin, in particular in a form-fitting manner. The recess is advantageously spaced apart from the axis of rotation. For example, the blocking device can be manually released, in particular by pulling the locking pin. However, the blocking device can generally also be electrically released, for example by controlling an electromagnet cooperating with the blocking device. Here, the blocking device advantageously has a latching mechanism that cooperates with the electromagnet and that is configured to block the pulling piece, wherein the latching mechanism can be released by controlling the electromagnet and the pulling piece can be rotated again.

According to a further advantageous embodiment, the drive unit can comprise a second base on which components of the drive unit can be arranged, whereby the actuating device can be easily manufactured. In particular, the drive unit can be easily fastened to a front side of a switch panel, for example, by means of the second base. The pulling cable is preferably supported at the second base, wherein the pulling cable can generally also be supported in another way, for example by means of a roller fastened to a switch panel. If the pulling cable is guided in a or the Bowden cable sheath, the second Bowden cable sheath end can be supported at the second base. For this purpose, the second base can comprise a cable counter-holder that receives the second Bowden cable sheath end. However, such a cable counter-holder can generally also be attached directly to the switch panel. Alternatively or additionally, the pulling piece can be rotatably supported at the second base about the axis of rotation. Further alternatively or additionally, the blocking device can be arranged at the second base.

According to a further advantageous embodiment, the pulling piece can comprise a guide mandrel that is spaced apart in parallel from the axis of rotation. The second base can have a second guide contour in which the guide mandrel is guided. Advantageously, the second guide contour has the shape of a circular ring segment. The ends of the circular ring segment can each form an abutment for the guide mandrel, whereby the pulling piece can only be rotated in a predefined angular range. Advantageously, the angular range predefined by means of the abutments can be matched to a movement of a switching contact of a switching apparatus that is performed by the switching contact when it is transposed into another switch position. The predefined angular range is advantageously matched to a movement of the switching contact of the switching apparatus such that the guide mandrel abuts the respective end of the second guide contour when the switching contact is in a respective end position or switching position. Thus, end positions of the switching device can be easily defined by means of the second guide contour. In particular, the angular range can be matched to the movement of the switching contact such that a force with which the switching contact is pressed against a contact of a busbar, for example due to a pulling force acting on the pulling cable, can be limited. For this purpose, the second guide contour can, for example, be configured such that the guide mandrel abuts one end of the second guide contour in a switch position of the switching contact of the switching apparatus. In particular, a defined contact pressure can thereby be set and damage can be reduced. The operation of the drive unit can also be simplified by the abutments since an operator can recognize with reference to an abutment that the pulling piece was sufficiently rotated for a change in a switch position. Furthermore, the guide mandrel can indicate a switch position of a switching apparatus in a visually perceivable manner.

The invention further relates to a switch panel of electrical energy technology, in particular of medium-voltage technology, comprising a switching apparatus and an actuating device mechanically coupled to the switching apparatus as disclosed herein.

Furthermore, the invention relates to a method for actuating a switching apparatus of a switch panel of electrical energy technology, in particular of medium-voltage technology, by means of an actuating device mechanically coupled to the switching apparatus. The actuating device can in this respect be designed as disclosed herein. The method comprises: operating a or the drive unit of the actuating device, whereby a pulling force is applied to a or the pulling cable such that a or the pivot unit mechanically coupled to the switching apparatus is pivoted, whereby the switching apparatus is actuated.

In general, the statements on the actuating device according to the invention apply accordingly to the switch panel according to the invention and the method according to the invention. This in particular applies with respect to embodiments and advantages. It is furthermore understood that all the features mentioned herein can be combined with one another, unless explicitly stated otherwise.

The invention will be described in the following by way of example with reference to the Figures. There are shown schematically

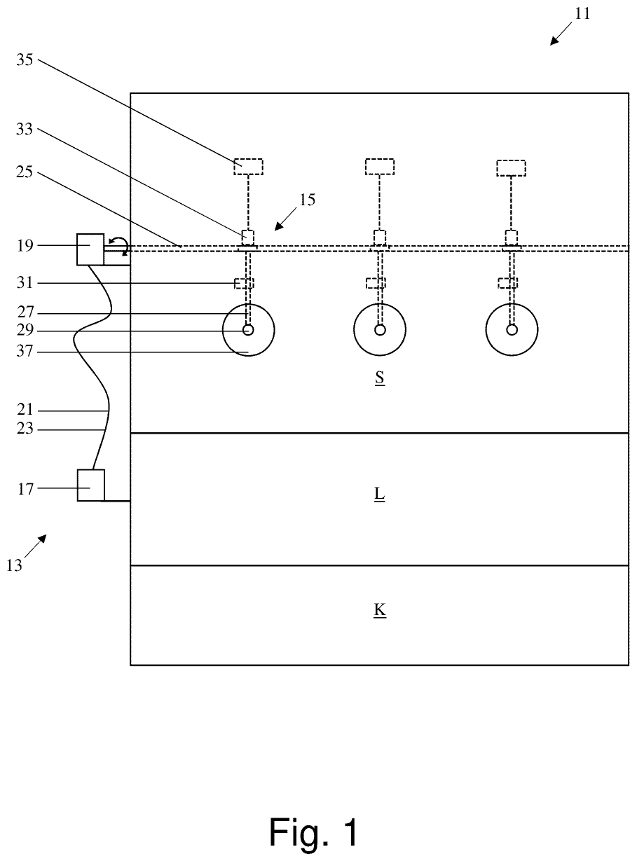

FIG. 1 a switch panel with an actuating device in a side view; and

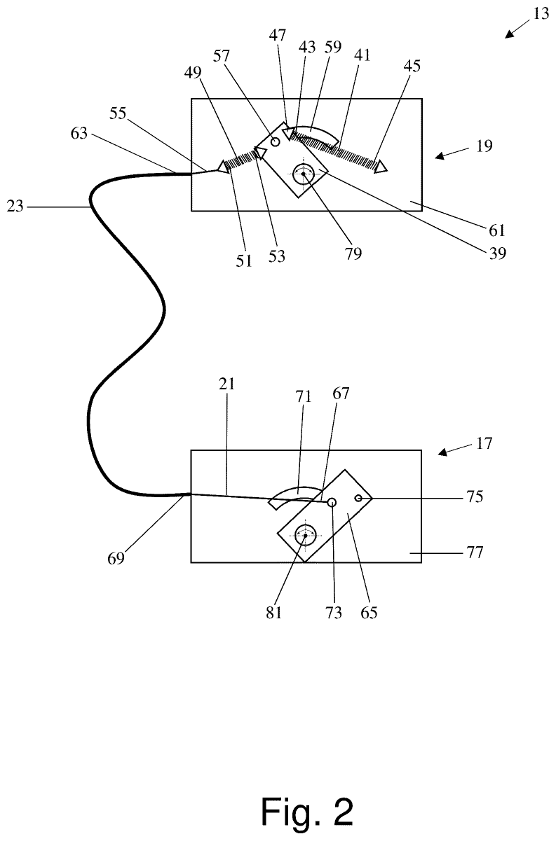

FIG. 2 the actuating device of FIG. 1 in a front view.

FIG. 1 shows, in a side view, a switch panel 11 of medium-voltage technology comprising a switching apparatus 15 and an actuating device 13 mechanically coupled to the switching apparatus 15. Elements disposed within the switch panel 11 are shown by dashed lines, wherein, for the sake of clarity, only elements that serve to illustrate the mode of operation of the actuating device 13 are shown.

Like conventional switch panels of medium-voltage technology, the switch panel 11 comprises a cable connection compartment K, a circuit breaker compartment L and a busbar compartment S that can be filled with an insulating gas such as sulfur hexafluoride to improve the electric strength. The switch panel 11 further comprises three busbars 29 that are each fed into the interior of the switch panel 11 by means of a bushing 37 and extend perpendicular to the drawing plane there. Each busbar 29 is in this respect assigned a phase of a three-phase system—the switch panel 11 is therefore three-phase. Purely for the sake of clarity, only the phase at the left in FIG. 1 will be discussed in more detail. However, it is already understood for symmetry reasons that the individual phases are essentially the same. It is further understood that the invention disclosed herein is also applicable to switch panels with a different number of phases, for example single-phase or two-phase systems.

To monitor the voltage at the busbar 29, the switch panel 11 comprises a voltage transformer 35 that is connected to the busbar 29 via a sliding contact 33 and a switching contact 27 in FIG. 1. The switch panel 11 further comprises the switching apparatus 15 by means of which the voltage transformer 35 can be disconnected from the busbar 29 and connected to ground potential. For this purpose, the switching apparatus 15 has a shaft 25 which is rotatably supported at the switch panel 11 (illustrated by a double arrow) and at which the switching contact 27 is rotationally fixedly arranged. The switch panel 11 further comprises a ground contact 31 that can be contacted by the switching contact 27. For this purpose, the switching contact 27 can be displaced by rotating the shaft 25 so that the switching contact 27 contacts the ground contact 31. The voltage transformer 35 is then connected to the ground contact 31 via the sliding contact 33 and the switching contact 27. Consequently, by rotating the shaft 25, the switching contact 27 can be transposed into a switch position in which the voltage transformer 35 is connected to the busbar 29 and into a switch position in which the voltage transformer 35 is disconnected from the busbar 29 and connected to the ground contact 31. It is understood that the shaft 25 is configured such that it does not cause any short-circuits, in particular between the individual phases.

The switching apparatus 15 of the switch panel 11 can be actuated by the actuating device 13 according to the invention, i.e. the switching contact 27 can be transposed from the one switch position into the other switch position. For this purpose, the actuating device 13 comprises a pivotable pivot unit 19 that is mechanically coupled to the shaft 25. The actuating device 13 further comprises a manually operable drive unit 17 that is mechanically connected to the pivot unit 19 via a pulling cable 21. The pulling cable 21 is guided in a Bowden cable sheath 23 whose ends are supported at the drive unit 17 or at the pivot unit 19. The actuating device 13 is configured such that an operation of the drive unit 17 applies a pulling force to the pulling cable 21 in the direction of the drive unit 17, whereby the pivot unit 19 is pivoted. The shaft 25 mechanically coupled to the pivot unit 19 is simultaneously pivoted so that the switching contact 27 is transposed from the switch position in which the voltage transformer 35 is connected to the ground contact 31 into the switch position shown in FIG. 1 in which the voltage transformer 35 is connected to the busbar 29.

FIG. 2 shows, in a front view, the actuating device 13 from FIG. 1 for the switch position of the switching contact 27 shown in FIG. 1. The pivot unit 19 comprises a connection piece 39 that is configured as rotatable in two directions (illustrated by a double arrow) about a pivot axis 79 and that is rotatably or pivotably supported at a first base 61. By means of the first base 61, the pivot unit 19 is fastened to the switch panel 11 from FIG. 1 such that the pivot axis of the shaft 25 and the pivot axis 79 of the connection piece 39 are the same within the scope of the manufacturing possibility. The connection piece 39 is rotationally fixedly screwed to the shaft 25 via a screw connection, not shown in detail.

The pivot unit 19 further comprises a return spring 41 that is configured as a tension spring and that has a first return spring end 43 and a second return spring end 45. With its first return spring end 43, the return spring 41 is connected in an articulated manner to the connection piece 39, via a screw lug 47, spaced apart from the pivot axis 79. With its second return spring end 45, the return spring 41 is connected in an articulated manner to the first base 61 via a screw lug.

Furthermore, the pivot unit 19 comprises a clamping spring 49 configured as a tension spring. The clamping spring 49 has a first clamping spring end 51 that is connected in an articulated manner to the pulling cable end 55 via a screw lug. The second clamping spring end 53 is connected in an articulated manner to the connection piece 39, via a screw lug, spaced apart from the pivot axis 79.

The connection piece 39 further comprises a guide pin 57 that is arranged spaced apart in parallel from the pivot axis 79. The first base 61 furthermore has a first guide contour 59 in the form of a circular ring segment in which the guide pin 57 is guided.

The drive unit 17 comprises a second base 77 and a pulling piece 65 rotatably supported at the second base 77 in two directions (illustrated by a double arrow) about an axis of rotation 81. The pulling piece 65 has a plug-in section (not shown) which is configured as connectable to a hand crank and onto which a hand crank can be plugged to operate the drive unit 17.

The pulling piece 65 further comprises a guide mandrel 73 which is spaced apart in parallel from the axis of rotation 81 and to which the pulling cable 21 is fastened with its pulling cable start 67. The second base 77 has a second guide contour 71 in the form of a circular ring segment in which the guide mandrel 73 is guided.

The drive unit 17 furthermore comprises a releasable blocking device 75 that is arranged at the second base 77 and that is configured to block the pivot unit 19 against a pivoting in the state shown in FIG. 2. For this purpose, the blocking device 75 comprises a locking bolt having a spring-loaded locking pin that is received in a form-fitting manner in a recess (not shown) formed in the pulling piece 65.

The pivot unit 19 is mechanically connected to the drive unit 17 via the pulling cable 21. The Bowden cable sheath 23 provided for guiding the pulling cable 21 in this respect comprises a first Bowden cable sheath end 63, which is supported at the first base 61 by means of a cable counter-holder not shown, and a second Bowden cable sheath end 69 that is supported at the second base 77 by means of a cable counter-holder, not shown.

As already mentioned, the state of the actuating device 13 shown in FIG. 2 corresponds to that switch position of the switching contact 27 in which the voltage transformer 35 is connected to the busbar 29. In this state, the guide pin 57 and the guide mandrel 73 abut an abutment of the first guide contour 59 or the second guide contour 71, whereby the force with which the switching contact 27 presses against a contact, not shown, at the busbar 29 is limited. The connection piece 39 is furthermore blocked against a pivoting since the blocking device 75 blocks the pulling piece 65.

Furthermore, in the state of the actuating device 13 shown in FIG. 2, the return spring 41 is tensioned so that, on a release of the blocking device 75, the connection piece 39 is pivoted while the return spring 41 relaxes until the guide pin 57 abuts the right-hand abutment of the guide contour 59 in FIG. 2. Since the return spring 41 is preloaded, the return spring does not relax completely in this respect, but only has a smaller tension compared to the state shown in FIG. 2. The clamping spring 49 is also preloaded and therefore does not relax completely in this respect, but only has a smaller tension compared to the state shown in FIG. 2. At the same time, with this pivot movement of the connection piece 39, the pulling piece 63 is co-rotated via the pulling cable 21 until the guide mandrel 73 abuts the left-hand abutment of the guide contour 71 in FIG. 2. With this pivoting of the connection piece 39, the shaft 25 is likewise pivoted, wherein the switching contact 27 is transposed from the switch position shown in FIG. 1, in which the switching contact 27 contacts the busbar 29, into that switch position in which the switching contact 27 contacts the ground contact 31. In this switch position, the voltage transformer 35 is disconnected from the busbar 29 and connected to ground potential. The force with which the switching contact 27 is in this respect pressed against the ground contact 31 can in particular be limited by the guide pin 57 abutting the right-hand end of the first guide contour 59 in FIG. 2.

To reconnect the voltage transformer 35 to the busbar 29, the pulling piece 65 can be rotated using the hand crank and can be blocked by means of the blocking device 75. In this respect, the connection piece 39 is pivoted into the state shown in FIG. 2 via the pulling cable 21 while the return spring 41 is tensioned again. The shaft 25 mechanically coupled to the connection piece 39 is simultaneously pivoted, wherein the voltage transformer 35 is disconnected from the ground contact 31 and the switching contact 27 is transposed into a switch position in which the voltage transformer 35 is connected to the busbar 29 via the sliding contact 33 and the switching contact 27.

### REFERENCE NUMERAL LIST

11 switch panel
13 actuating device
15 switching apparatus
17 drive unit
19 pivot unit
21 pulling cable
23 Bowden cable sheath
25 shaft
27 switching contact
29 busbar
31 ground contact
33 sliding contact
35 voltage transformer
37 bushing
39 connection piece
41 return spring
43 first return spring end
45 second return spring end
47 screw lug
49 clamping spring
51 first clamping spring end
53 second clamping spring end
55 pulling cable end
57 guide pin
59 first guide contour
61 first base
63 first Bowden cable sheath end
65 pulling piece
67 pulling cable start
69 second Bowden cable sheath end
71 second guide contour
73 guide mandrel
75 blocking device
77 second base
79 pivot axis
81 axis of rotation
S busbar compartment
L circuit breaker compartment
K cable connection compartment

1. An actuating device for a switching apparatus of a switch panel of electrical energy technology, said actuating device comprising
an operable drive unit,
a pulling cable that is fastened to the drive unit with its pulling cable start, and
a pivot unit that can be mechanically coupled to the switching apparatus and that is mechanically connected to the drive unit via the pulling cable.

2. The actuating device according to claim 1, wherein the switch panel is of medium-voltage technology.

3. The actuating device according to claim 1, wherein the pivot unit comprises a connection piece that is configured as pivotable about a pivot axis and the pulling cable is connected to the connection piece with its pulling cable end spaced apart from the pivot axis.

4. The actuating device according to claim 3, wherein the pivot unit comprises a return spring that that is fastened to the connection piece spaced apart from the pivot axis.

5. The actuating device according to claim 4, wherein the return spring is configured as a tension spring.

6. The actuating device according to claim 4, wherein the return spring is connected in an articulated manner to the connection piece spaced apart from the pivot axis.

7. The actuating device according to claim 1, wherein the pivot unit comprises a first base at which the pulling cable is supported, at which the connection piece is pivotably supported about the pivot axis, and/or to which the return spring is fastened.

8. The actuating device according to claim 7, wherein the return spring is connected in an articulated manner to the connection piece.

9. The actuating device according to claim 7, wherein the connection piece comprises a guide pin that is spaced apart in parallel from the pivot axis, wherein the first base has a first guide contour in which the guide pin is guided.

10. The actuating device according to claim 3, wherein the pivot unit comprises a clamping spring that is configured as a tension spring and that is fastened to the connection piece at the pulling cable end and spaced apart from the pivot axis.

11. The actuating device according to claim 10, wherein the clamping spring is configured as a tension spring.

12. The actuating device according to claim 10, wherein the clamping spring is connected in an articulated manner to the connection piece at the pulling cable end and spaced apart from the pivot axis.

13. The actuating device according to claim 1, wherein the pulling cable is guided in a Bowden cable sheath.

14. The actuating device according to claim 1, wherein the drive unit is configured to apply a pulling force to the pulling cable in order to pivot the pivot unit.

15. The actuating device according to claim 1, wherein the drive unit comprises a pulling piece that is configured as rotatable about an axis of rotation, wherein the pulling cable is connected to the pulling piece with its pulling cable start spaced apart from the axis of rotation.

16. The actuating device according to claim 15, wherein the pulling piece has a plug-in section that is configured as connectable to a hand crank.

17. The actuating device according to claim 1, wherein the drive unit comprises a releasable blocking device that is configured to block the pivot unit against a pivoting.

18. The actuating device according to claim 15, wherein the drive unit comprises a releasable blocking device that is configured to block the pivot unit against a pivoting, and wherein the blocking device comprises a locking bolt having a spring-loaded locking pin and the pulling piece has a recess configured as receiving the locking pin in a form-fitting manner.

19. The actuating device according to claim 15, wherein the drive unit comprises a second base at which the pulling cable is supported, at which the pulling piece is rotatably supported about the axis of rotation, and/or at which the blocking device is arranged.

20. The actuating device according to claim 19, wherein the pulling piece comprises a guide mandrel that is spaced apart in parallel from the axis of rotation, wherein the second base has a second guide contour in which the guide mandrel is guided.

21. A switch panel of electrical energy technology, comprising a switching apparatus and an actuating device that is mechanically coupled to the switching apparatus, said actuating device comprising
an operable drive unit,
a pulling cable that is fastened to the drive unit with its pulling cable start, and
a pivot unit that can be mechanically coupled to the switching apparatus and that is mechanically connected to the drive unit via the pulling cable.

22. A method for actuating a switching apparatus of a switch panel of electrical energy technology by means of an actuating device that is mechanically coupled to the switching apparatus, said method comprising: operating a drive unit of the actuating device, whereby a pulling force is applied to a pulling cable such that a pivot unit mechanically coupled to the switching apparatus is pivoted, whereby the switching apparatus is actuated.

23. The method according to claim 22, wherein the actuating device comprises
the drive unit that is an operable drive unit,
the pulling cable that is fastened to the drive unit with its pulling cable start, and
the pivot unit that can be mechanically coupled to the switching apparatus and that is mechanically connected to the drive unit via the pulling cable.
